(19) United States
(12) Patent Application Publication
(10) Pub. No.: US 2003/0031139 A1
(43) Pub. Date: Feb. 13, 2003

(54) Echo cancellation circuit

(76) Inventor: Stephen C. Thilenius, Cameron Park, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/924,334

(22) Filed: Aug. 6, 2001

(51) Int. Cl. H04B 3/20; H04M 9/08

(52) U.S. Cl. 370/286; 370/292; 379/406.01

(57) ABSTRACT

A system and method for echo cancellation in digital subscriber line (DSL) service using passive devices. The outgoing transmitted signal is attenuated and fed back into the receiver circuit in such a way as to maximize the canceling of the transmitted signal and thus allow the receiver circuit to amplify and process the received signal without interference from the outgoing transmitted signal. The feedback circuit uses only passive elements. The feedback circuit has complex impedance branches. These complex impedance branches parallel the complex impedances of the transformer and transmission line such that any change in the transformer or transmission line impedance is similarly experienced in the feedback circuit. This allows for near total cancellation of the echo signal without the need for costly active circuits.

### TECHNICAL FIELD

This invention relates to transmission/receiver circuits, and more particularly to an echo cancellation circuit used in DSL communications.

### BACKGROUND

In many communications systems a single data path transmits and receives data signals. As an example, in digital subscriber line (DSL) service, the home user transmits and receives signals over a twisted pair of wires. At any given moment, the twisted pair of wires can be carrying both outgoing and incoming signals.

Echo cancellation circuits aid in the reception of the incoming signals. More specifically, echo cancellation circuits compensate for the reflection, or echo, of outgoing signals into the receiver circuit. This results in the receiver circuit receiving a cleaner incoming signal for amplification and processing.

In general, there are two types of echo cancellation circuits. The first type includes active circuits and memories. These echo cancellation circuits are trained to compensate for a particular transmission line and terminator impedance, and to adapt to changes in this impedance as the temperature and frequency of outgoing signals change. The second type of echo cancellation circuit includes resistors to reduce the reflection of the outgoing signals into the receiver circuit.

### DESCRIPTION OF DRAWINGS

FIG. 1 is a circuit diagram of a resistive, passive echo cancellation circuit.

FIGS. 2a, 2b and 2c are simplified circuit diagrams of the circuit shown in FIG. 1.

FIGS. 3 and 4 are graphs of the relationship between impedance and frequency.

FIG. 5 is a circuit diagram of an improved echo cancellation circuit.

FIGS. 6-8 are simplified circuit diagrams of the circuit of FIG. 5.

Like reference symbols in the various drawings indicate like elements.

### DETAILED DESCRIPTION

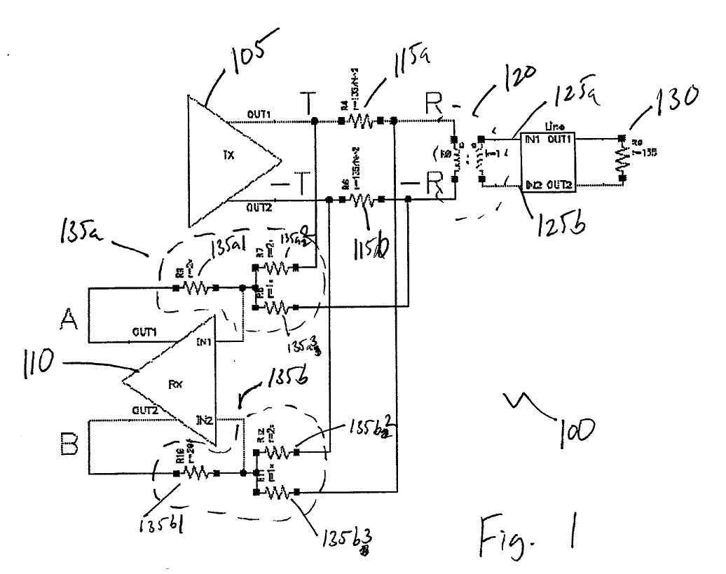

An improved echo cancellation circuit employs both reactive elements, (e.g., capacitors and inductors) and resistive elements (e.g., resistors) such that the impedance of the circuit has both real and imaginary components. This arrangement permits the circuit to more closely track variations in the impedance of a transmission line and associated transformer due to variations in a frequency of a signal being transmitted. For ease of discussion, an echo cancellation circuit including resistive elements is discussed with reference to FIGS. 1-4 before the improved circuit is discussed with reference to FIGS. 5-8. Referring to FIG. 1, circuit 100 includes transmitter 105 and receiver 110. Transmitter 105 issues differential output signals onto nodes T and −T, while receiver 110 receives differential input signals on nodes R and −R. A terminating resistor 115a is coupled between nodes T and R, and a terminating resistor 115b is coupled between nodes −T and −R. A transformer 120 couples nodes R and −R to a twisted pair of transmission lines 125a and 125b. A resistor 130 represents the impedance of the transmitter and/or receiver circuit(s) coupled to transmission lines 125a and 125b.

There are two cancellation circuits 135a and 135b for cancelling the outgoing transmitted signal. Cancellation circuit 135a is coupled to nodes T and −R and includes three resistors 135a1, 135a2 and 135a3. Similarly, cancellation circuit 135b is coupled to nodes −T and R and includes three resistors 135b1, 135b2 and 135b3.

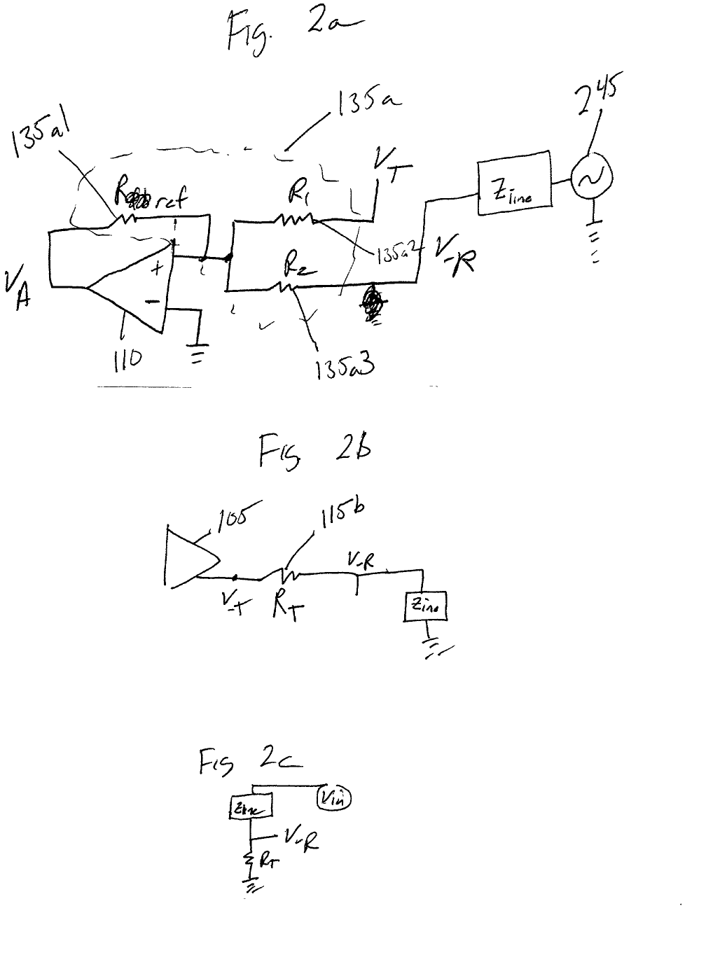

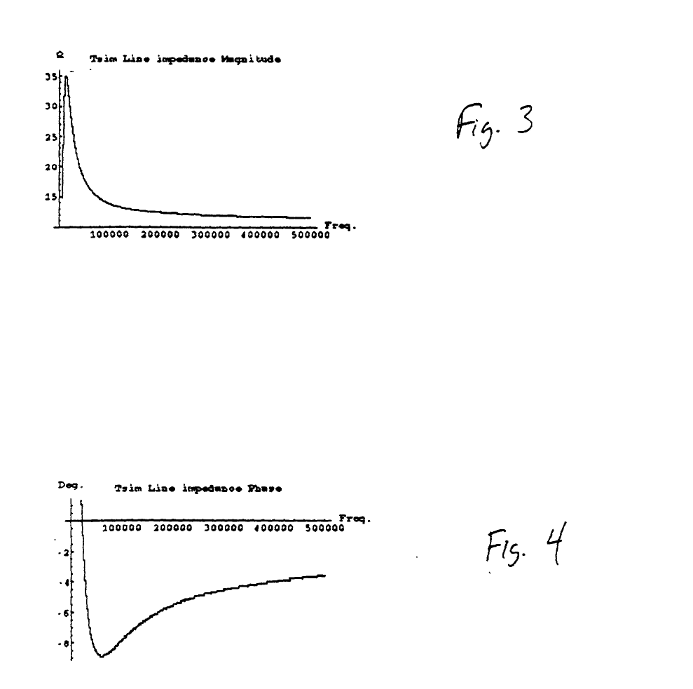

FIG. 2a shows only the cancellation circuit 135a for ease of discussion. It should be understood that a similar diagram and analysis can be done for cancellation circuit 135b. To simplify the analysis, the impedances of transformer 120 and transmission lines 125a and 125b are represented by impedance Zₗᵢₙₑ. Voltage source 245 represents an incoming signal to be detected, amplified and processed by receiver 110. The outgoing signal, which is transmitted as a differential signal from nodes T and −T, is reduced so as not to be amplified and processed as an incoming, received signal by receiver 110.

Cancellation circuit 135a, in conjunction with receiver circuit 110, operates as a voltage summer. Thus, the voltage at node A, V_{A}, is given by the following equation where V_{T} is the voltage at node T, V_{-R} is the voltage at node −R, R_{ref} is the resistance value of resistor 135a1, R₁ is the resistance value of resistor 135a2 and R₂ is the resistance value of resistor 135a3:

$${V}_{A} = {V}_{T} ( \frac{{R}_{ref}}{{R}_{1}} ) + {V}_{- R} ( \frac{{R}_{ref}}{{R}_{2}} ) .$$

Assuming R₁=R_{ref} and R₂=½ R_{ref}, this simplifies to:

V_{A}=V_{T}+(2)V_{-R}.

The voltage at node −R, V_{-R} is a combination of the voltage output from transmitter 105, V_{-T}, and the input voltage, Vᵢₙ, received through transformer 120. Thus V_{-R} may be expressed as the sum of a component, V_{-RT}, provided by V_{-T} and a component, V_{-Rin}, provided by Vᵢₙ:

V_{-R}=V_{-RT}+V_{-Rin}.

Referring to FIG. 2b, using superposition to calculate the influence that V_{-T} has on V_{-R}, and setting the resistance of terminating resistor 115b to R_{T} yields the following equation:

$${V}_{- RT} = {V}_{- T} [ \frac{{Z}_{line}}{{R}_{T} + {Z}_{line}} ] .$$

Referring to FIG. 2c and using superposition to calculate the influence that Vᵢₙ has on V_{-R} when V_{-T} is grounded produces the following equation:

$${V}_{- Rin} = {V}_{i n} [ \frac{{R}_{T}}{{R}_{T} + {Z}_{line}} ] .$$

Substituting the equations for V_{-RT} and V_{-Rin} into the equation for V_{-R} yields:

$${V}_{- R} = {V}_{- T} [ \frac{{Z}_{line}}{{R}_{T} + {Z}_{line}} ] + {V}_{i n} [ \frac{{R}_{T}}{{R}_{T} + {Z}_{line}} ] .$$

Assuming that the terminating resistor 115b matches the combined impedance of transformer 120 and transmission lines 125a and 125b, that is Zₗᵢₙₑ=R_{T}, the equation for V_{-R} reduces to:

$${V}_{- R} = {V}_{- T} ( \frac{1}{2} ) + {V}_{i n} ( \frac{1}{2} ) .$$

Since the outgoing transmitted signal is differential, it follows that V_{-T}=−(V_{T}) Substituting this value into the equation for V_{-R}, and then substituting the equation for V_{-R} into the equation for V_{A} yields:

$${V}_{A} = {V}_{T} ( 1 ) + [ - {V}_{T} ( \frac{1}{2} ) ( 2 ) ] + {V}_{i n} ( \frac{1}{2} ) ( 2 ) ,$$

which reduces to:

V_{A}=Vᵢₙ.

This analysis shows that the echo cancellation circuits 135a and 135b of FIG. 1 are effective at reducing the echo of V_{T} and V_{-T} onto nodes A and B as long as the impedance of terminating resistors 115a and 115b matches the combined impedance of transformer 120 and transmission lines 125a and 125b.

As noted above, the impedance Zₗᵢₙₑ represents both the impedance of the transmission lines 125a and 125b (e.g., the twisted pair of telephone lines outside of the user's home) and the transformer 120 of FIG. 1. The individual impedances of these components vary with the frequency of the signals they carry and the ambient temperature. In other words, Zₗᵢₙₑ is not constant and does not always equal the resistances of terminating resistors 115a and 115b (R_{T}).

For DC signals, the impedance of transformer 120 is approximately 0 Ω. Thus, the dominant factor in impedance Zₗᵢₙₑ is the impedance of transmission lines 125a and 125b. As the frequency of the signals increases from 0 Hz to about 5 kHz, the impedance of transformer 120 increases, which in turn causes the impedance Zₗᵢₙₑ to increase as shown in FIG. 3.

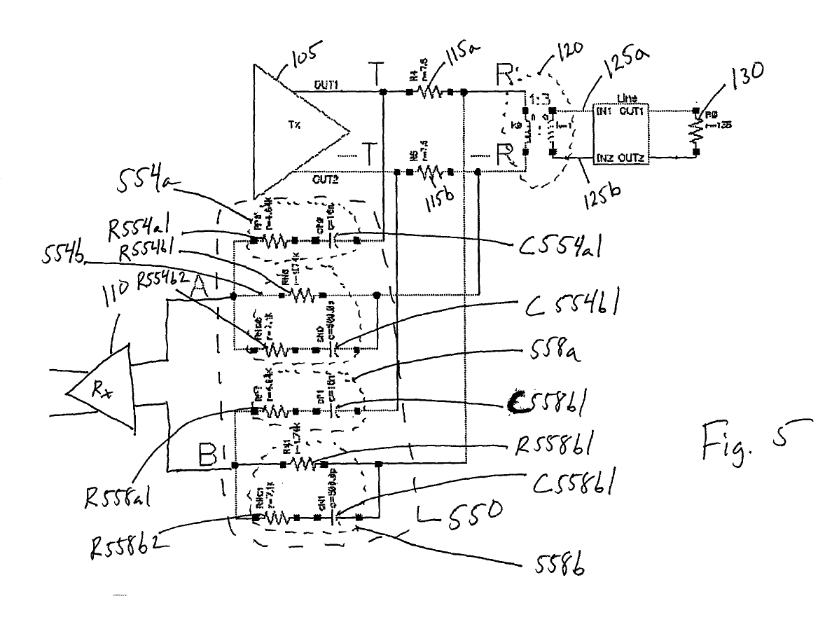

Above 5 kHz, the impedance of transmission lines 125a and 125b decreases substantially to dominate the impedance Zₗᵢₙₑ. Thus, for signals above 5 kHz (e.g., from 5 kHz to 10 kHz), the impedance Zₗᵢₙₑ decreases. FIGS. 3 and 4 show the variations in the complex impedance Zₗᵢₙₑ as the frequency increases. As shown, compensating for these variations in impedance using only resistive elements is virtually impossible.

FIG. 5 illustrates a circuit having many elements that are the same as elements of the circuit of FIG. 1 and are referred to with the same reference numbers. Cancellation circuit 550 is coupled between nodes T, −T, R and −R and the receiver 110 input nodes A and B. Cancellation circuit 550 includes four separate impedance branches 554a, 554b, 558a and 558b that are coupled, respectively, between nodes T and A, and nodes −R and A, nodes −T and B, and nodes −R and B.

Impedance branch 554a includes resistor R554a1 and capacitor C554a1 coupled in series. Impedance branch 554b includes resistor R554b1 coupled in parallel with a series combination of resistor R554b2 and capacitor C554b1. Impedance branch 558a includes a series combination of resistor R558a1 and capacitor C558a1. Impedance branch 558b includes resistor R558b1 coupled in parallel with a series combination of resistor R558b2 and capacitor C558b1. In one implementation, each of R554a1 and R558a1 has a value of 4.6 kΩ; each of C554a1 and C558a1 has a value of 16 nanoFarads; each of R554b1 and R558b1 has a value of 1.7 kΩ; each of R554b2 and R558b2 has a value of 7.1 kΩ; and each of C554b1 and C558b1 has a value of 1 nanoFarad.

Each of the four impedance branches 554a, 554b, 558a and 558b includes resistive elements (i.e., the resistors) and reactive elements (i.e., the capacitors). The use of both resistors and capacitors produces complex impedances. In other words, each branch has real impedance components based substantially on the values of the resistors and imaginary impedance components based substantially on the values of the capacitors.

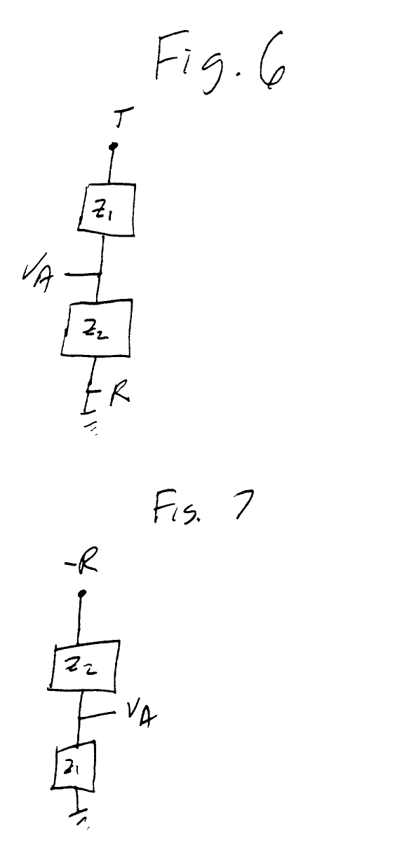

The circuits shown in FIGS. 6-8 are analyzed to describe the behavior of the circuit shown in FIG. 5. For brevity and clarity, only half of cancellation circuit 550 that includes impedance branches 554a and 554b is described. It should be understood that the following analysis also applies to impedance branch 558a and 558b of the cancellation circuit. Using superposition, several of the nodes, T, R and −R are grounded and the resulting characteristic equations are calculated. Also for the sake of brevity, the impedance of branch 554a is defined as Z₁ and the impedance of branch 554b is defined as Z₂.

The voltage at node A, V_{A}, includes a component, V_{AT}, attributable to the voltage at node T, and a component, V_{A-R}, attributable to the voltage at node −R:

V_{A}=V_{AT}+V_{A-R}.

In FIG. 6, node −R is grounded so that V_{A-R} equals zero and V_{AT} is calculated to determine the effect of echoing the transmitted voltage onto nodes A and B. By voltage division, V_{AT} is:

$${V}_{AT} = {V}_{T} [ \frac{{Z}_{2}}{{Z}_{1} + {Z}_{2}} ] .$$

In FIG. 7, node T is grounded so that VAT equals zero and V_{A-R} is calculated to determine the effect of the voltage at node −R on node A. By voltage division, V_{A-R} is:

$${V}_{A - R} = {V}_{- R} [ \frac{{Z}_{1}}{{Z}_{1} + {Z}_{2}} ] .$$

As described earlier, V_{-R} is itself a combination of the signals received through transformer 120 from outside circuits as well as the signals output by transmitter 105 that are propagated to node −R through terminating resistor 115b. The voltage applied to node −R from transformer 120 due to received input signals is ignored.

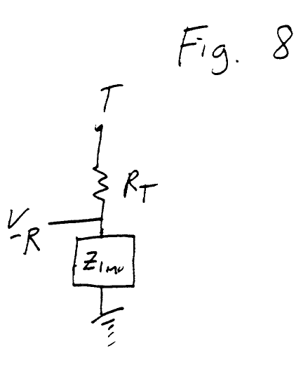

Grounding node R in FIG. 5 produces the equivalent circuit shown in FIG. 8. The relationship between V_{-T} and V_{-R} is derived through voltage division to be:

$${V}_{- R} = {V}_{- T} [ \frac{{Z}_{line}}{{Z}_{line} + {R}_{T}} ] ,$$

and substituting V_{T} for V_{-T} produces:

$${V}_{- R} = - {V}_{T} [ \frac{{Z}_{line}}{{Z}_{line} + {R}_{T}} ] .$$

Substituting for V_{-R}, V_{AT}, and V_{A-R} in the equation for V_{A} using the equations above yields:

$${V}_{A} = {V}_{T} [ \frac{{Z}_{2}}{{Z}_{1} + {Z}_{2}} ] + ( - {V}_{T} ) [ \frac{{Z}_{line}}{{Z}_{line} + {R}_{T}} ] [ \frac{{Z}_{1}}{{Z}_{1} + {Z}_{2}} ] ,$$

which may be rewritten as:

$${V}_{A} = [ \frac{{V}_{T}}{{Z}_{1} + {Z}_{2}} ] [ {Z}_{2} - {Z}_{1} ( \frac{{Z}_{line}}{{Z}_{line} + {R}_{T}} ) ] .$$

From the preceding equation, it is clear that the transmitted output voltage V_{T} can be eliminated from nodes A and B if

$${Z}_{2} = \frac{{Z}_{1} \times {Z}_{line}}{{Z}_{line} + {R}_{T}} ,$$

which may be rewritten as:

$$\frac{{Z}_{2}}{{Z}_{1}} = \frac{{Z}_{line}}{{Z}_{line} + {R}_{T}} .$$

Thus, by designing the impedances within each of the branches in cancellation circuit 550 to be correlate with the impedances of Zₗᵢₙₑ and the terminating resistors R_{T}, the echo of the outgoing transmission signal, V_{T} and V_{-T}, into receiver circuit 110 is reduced or eliminated. In other words, as long as Z₂ varies in the same proportion with Zₗᵢₙₑ as Z₁ varies in proportion with Zₗᵢₙₑ and R_{T}, the reflection or echo of the transmitted output voltage into the receiver 110 is reduced or eliminated. Impedance branches 554a, 554b, 558a and 558b have complex impedances in order to correlate more closely with the complex impedance of the combination of Zₗᵢₙₑ and R_{T}.

In FIG. 5, each impedance branch 554a, 554b, 558a and 558b includes capacitors. Capacitors are reactive elements. By using resistors and capacitors in the impedance branches, the frequency response of echo cancellation circuit 550 more closely models the frequency response of the transformer 120 and transmission lines 125a and 125b combination. Thus, the amount of the outgoing transmitted signal from transmission circuit 105 that is echoed into receiver circuit 110 is attenuated or eliminated even as the impedance of the transmission line and transformer combination varies with frequency.

Generally, cancellation circuit 550 operates as follows. As the frequency of the output signals from transmitter 105 increases, the impedance of transformer 120 increases. This results in more of the output transmission voltages V_{T} and V_{-T} being present on nodes R and −R, respectively. To compensate for this, relatively large capacitors C554a1 and C558a1 and resistors R554a1 and R558a1 are used to propagate more of the opposite polarity signals V_{T} and V_{-T} directly into nodes A and B, respectively. In other words, as the voltage at node −R rises due to the increase in the impedance of transformer 120, a larger portion of the opposite polarity signal V_{T} is propagated into node A through impedance branch 554a to compensate for the increase in voltage at node A caused by the increase in voltage at node−R. Thus, V_{T} is attenuated less by branch 554 so as to balance the increase in the voltage at node −R. Similar behavior occurs at node B as a result of the behavior of impedance branch 558a.

As the output signal frequencies increase beyond a certain point (e.g., 5 kHz), the impedance of transmission lines 125a and 125b increases and the impedance of transformer 120 decreases. This causes an overall decrease in Zₗᵢₙₑ as described above. With a decrease in Zₗᵢₙₑ, the effect of the output voltage becomes less of a factor in V_{-R}. However, V_{T} is still propagated to V_{A}. To compensate for this, V_{-R} is attenuated less so that a larger portion of V_{-R} is fed into node A. This is accomplished by having the impedance of series combination R554b2 and C554b1 decrease with increasing frequency. The decrease in impedance in that combination causes an overall decrease in impedance in branch 554b and a resulting increase in the voltage V_{-R} propagated onto node A.

The echo cancellation circuit 550 has at least two advantages over other echo cancellation circuits. First, no active elements are used. Thus, this circuit is relatively inexpensive and simple in design while still providing a close correlation to the combined impedance of transformer 120 and transmission lines 125a and 125b. In addition, it does not need to be trained or biased with a DC power supply in order to operate properly.

Second, the echo cancellation circuit 550 maps more closely with changes in the combined transmission line and transformer impedance resulting from changes in the frequency of the transmitted signals. In other words, the echo cancellation circuit 550 better compensates for changes in the transmission line and transformer impedance than echo cancellation circuits that only include resistors. This is because each branch 554a, 554b, 558a and 558b has complex impedance (i.e., real and imaginary components). Thus, the outgoing transmission signal reflection into receiver 110 is substantially reduced over a wider range of frequencies.

A number of implementations have been described. Nevertheless, it will be understood that various modifications may be made. For example, inductors can be used instead of the capacitors shown in FIG. 5. When using inductors, the value and arrangement (i.e., serial vs. parallel and vice versa) with the resistors will differ from the arrangement and values of resistors described above. In addition, while one implementation has the resistors formed on an integrated circuit along with either the transmitter circuit 105, the receiver circuit 110, or both, and the capacitors being discrete and external to the integrated circuit, other implementations may have all elements of the cancellation circuit integrated with the transmitter 105, the receiver 110, or both. Additionally, all elements of the cancellation circuit may be implemented externally to the integrated circuit containing the transmitter 105, the receiver 110, or both.

Accordingly, other implementations are within the scope of the following claims.

What is claimed is:

1. An echo cancellation circuit coupled between a transmitter and a receiver, the echo cancellation circuit comprising:
a first branch including real and imaginary impedances coupled between the transmitter and the receiver; and
a second branch including real and imaginary impedances coupled between the transmitter and the receiver.

2. The echo cancellation circuit of claim 1 wherein the first branch includes a resistor and a capacitor coupled together in series.

3. The echo cancellation circuit of claim 2 wherein the second branch includes a first resistor coupled in series with a capacitor and a second resistor coupled in parallel with the first resistor and the capacitor.

4. The echo cancellation circuit of claim 3 wherein the echo cancellation circuit is implemented in a transmitter/receiver circuit which has a terminating resistor and a transformer coupled to a transmission line.

5. The echo cancellation of claim 4 wherein a total impedance of the first branch is proportional to a combined impedance of the transformer and the transmission line combination over a range of frequencies.

6. The echo cancellation circuit of claim 5 wherein a total impedance of the second branch is proportional to a sum of the combined impedance of the transformer and transmission line combination and an impedance of the terminating resistor over a range of frequencies.

7. The echo cancellation circuit of claim 6 wherein the range of frequencies is 0 kHz to 10 kHz.

8. The echo cancellation circuit of claim 1 wherein the second branch includes a first resistor coupled in series with a capacitor and a second resistor coupled in parallel with the first resistor and the capacitor.

9. An echo cancellation circuit coupled between a transmitter and a receiver, the echo cancellation circuit comprising:
a first branch including real and imaginary impedances coupled between the transmitter and the receiver;
a second branch including real and imaginary impedances coupled between the transmitter and the receiver;
a third branch including real and imaginary impedances coupled between the transmitter and the receiver; and
a fourth branch including real and imaginary impedances coupled between the transmitter and the receiver.

10. The echo cancellation circuit of claim 9 wherein the first branch and the third branch each include a resistor and a capacitor coupled together in series.

11. The echo cancellation circuit of claim 10 wherein the second branch and the fourth branch each include a first resistor coupled in series with a capacitor and a second resistor coupled in parallel with the first resistor and the capacitor.

12. The echo cancellation circuit of claim 11 which is implemented in a transmitter/receiver circuit which has a terminating resistor and a transformer coupled to a transmission line.

13. The echo cancellation of claim 12 wherein a total impedance of each of the first branch and the third branch is proportional to a combined impedance of the transformer and transmission line combination.

14. The echo cancellation circuit of claim 13 wherein a total impedance of each of the second branch and the fourth branch is proportional to a sum of the combined impedance of the transformer and transmission line combination and the impedance of the terminating resistor.

15. A method of receiving an input signal and canceling an output transmission signal comprising:
transmitting the output transmission signal over a first terminal and a second terminal;
receiving the input signal over a third terminal and a forth terminal;
attenuating a first part of the transmitting signal through a first complex impedance; and
attenuating a second part of the transmitting signal through a second complex impedance.

16. The method of claim 15 further comprising:
further comprising matching a line impedance through a first terminating resistance and a second terminating resistance.

17. The method of claim 16 further wherein attenuating the first part of the transmitting signal comprises dividing of a voltage of the first part of the transmitting signal.

18. The method of claim 17 wherein the dividing involves the first complex impedance being proportional to a combination of the line impedance and an impedance of the first terminating resistance line impedance.

19. The method of claim 16 wherein attenuating the second part of the transmitting signal comprises dividing of a voltage of the second part of the transmitting signal.

20. The method of claim 19 wherein dividing involves the second complex impedance being proportional to a line combination of the line impedance and an impedance of the second terminating resistance impedance.

21. The method of claim 15 further comprising amplifying the input signal.
